(19) United States
(12) Patent Application Publication
(10) Pub. No.: US 2019/0231012 A1
(43) Pub. Date: Aug. 1, 2019

(54) SYSTEMS AND METHODS FOR PREPARING CUSTOM CLOTHING PATTERNS

(71) Applicant: UNDER ARMOUR, Baltimore, MD (US)

(72) Inventors: Jennifer DACZEWITZ, Baltimore, MD (US); Jami DUNBAR, Baltimore, MD (US); Erin SUDECK, Baltimore, MD (US)

(73) Assignee: UNDER ARMOUR, Baltimore, MD (US)

(21) Appl. No.: 16/263,172

(22) Filed: Jan. 31, 2019

Related U.S. Application Data
(60) Provisional application No. 62/624,252, filed on Jan. 31, 2018.

(51) Int. Cl. A41H 3/00; G06T 7/60; G06K 9/52

(52) U.S. Cl. CPC A41H 3/007; G06K 9/52; G06T 7/60

(57) ABSTRACT

Methods and systems of preparing custom clothing patterns are described. In particular, custom clothing patterns are prepared by obtaining a 2-D image of an individual, determining points of measurements of the individual from the 2-D image utilizing a body morphology technology, and modulating a digital clothing pattern template comprising measurement locations corresponding to the points of measurements by applying the measurements to the corresponding measurement locations of the digital pattern template, and altering the pattern based on the measurements and personal preferences.

### TECHNICAL FIELD

The present invention relates to a system and method for preparing custom clothing patterns utilizing body images and measurements.

### BACKGROUND

Properly fitting clothing is hard to find at a reasonable cost. Most affordable clothing is off-the-rack or ready-to-wear, meaning that most clothes are sized to fit the average of a group rather specifically tailored to each person. As such, most ready-to-wear clothing fits poorly. On the other hand, clothes specifically tailored for a person, such as made-to-measure clothing, require the time and attention of a tailor, and are therefore more expensive and less desirable to most people.

Conventional techniques for generating clothing patterns also require a large product inventory.

One approach for obtaining made-to-measure clothing without requiring a tailor, and therefore at a cheaper cost, is for a person to have their body measured by a body scan, which has been recently possible with the advent of new technology. However, while body scanning technology permits precise measurements and can offer a three-dimensional image of the person's body, it predominantly relies on generic avatars that resemble mannequins and lack any distinctive human qualities, let alone reflect the appearance of the consumer, or the person for whom the clothes are being purchased. Consequently, not only is there a lack of realism that creates an emotional distance that prevents acceptance by the purchaser, but the purchaser is also unable to gain a realistic feel for how the garment will look specifically on them. The lack of a buy-in and accurate appreciation for how the clothes will look on the purchaser lead to fewer repeat purchases and may even increase product returns by dissatisfied customers.

### SUMMARY

The disclosure is directed to methods and systems of preparing custom clothing patterns in accordance with some embodiments of the invention. In particular, the disclosure is directed to obtaining a 2-D image of an individual, determining points of measurements of the individual from the 2-D image and utilizing body morphology techniques, and modulating a digital clothing pattern template comprising measurement locations corresponding to the points of measurements by applying the measurements to the corresponding measurement locations of the digital pattern template and altering the pattern based on the measurements.

In some embodiments the method comprises the step of refining the altered pattern based on physical dimensions and characteristics of the individual.

In some embodiments, the method comprises the step of refining by the individual selecting a predetermined fit and style regardless of or in addition to the dimensions and physical characteristics of the individual.

In some embodiments, the 2-D image or refined pattern, or both, of the individual being fitted is stored on a remote server for access by designers and/or the individual during the fitting process.

In some embodiments, the 2-D image comprises acquiring values from measurement taken from the left side of the body without regard to the measurements from the right side of the body, or vice versa.

In some embodiments, modulating of the digital clothing pattern template is performed automatically without user input.

In some embodiments, the 2-D image is obtained by a body scanner or mobile device through the use of photography or scanning technology.

In some embodiments, the 2-d image is generated by an imaging device and provided to a user's computer. In some embodiments, the computer comprises a personal computer or mobile device.

The disclosure is also directed to an electronic device where a method for viewing clothing on a 2-d image of an individual is performed. The method includes selecting a 2-D image of an individual that is associated with measurements of the individual and applying body morphology to identify a body type; providing a select number of measurement points; e.g., 21-points of measure, selecting an image of a piece of clothing to apply to the 2-D image where the clothing is associated with a pattern comprising the corresponding points of measure; assigning the measurements from the individual to the corresponding measurement locations; and re-sizing the image of the piece of clothing relative to the measurements of the individual.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a flow diagram of an exemplary but not exclusive method for preparing custom clothing patterns practiced in accordance with some embodiments of the invention;

FIG. 2 is a block diagram of an illustrative electronic device for previewing application of beauty cosmetics in accordance with some embodiments of the invention.

FIGS. 3A-3U illustrate different measurement locations utilized for the present invention according to on embodiment.

FIGS. 4A-4D illustrate four different exemplary male morphologies utilized by one embodiment the present invention.

FIGS. 5A-5E illustrate five different exemplary female morphologies utilized by one embodiment the present invention.

### DETAILED DESCRIPTION

In accordance with the various embodiments, there is described herein, a method for manufacturing a customized garment for a customer based on preferences and size of the customer. The method comprises creating a pattern for the garment to be manufactured and determining at least a portion of the body of the customer based on the created pattern. The method further comprises photographing and/or scanning, by a camera and/or scanner, the at least the portion of the body of customer to determine sizing requirements for the garment to manufactured and then customizing/grading/matching the pattern for the garment to be manufactured based on the determined sizing requirement. The method further comprises manufacturing the garment based on the customized design for the garment. The matching scale can be selected by the customer or the designer.

Further, in accordance with the various embodiments of the present technology, there is described herein, a system for manufacturing a customized garment for a customer based on preferences and sizing requirements of the customer. The system comprises a computing device for creating a pattern for a garment based on the user inputs and determining at least a portion of the body of the customer based on the created pattern. The system further comprises a scanner configured to scan at least the portion of the body of the customer based on the created pattern. The system further comprises a processor configured to determine the sizing requirements for the garment to be manufactured based on the scanned at least the portion of the body of the customer and for customizing the pattern for the garment to be manufactured based on the determined size for the garment to be manufactured.

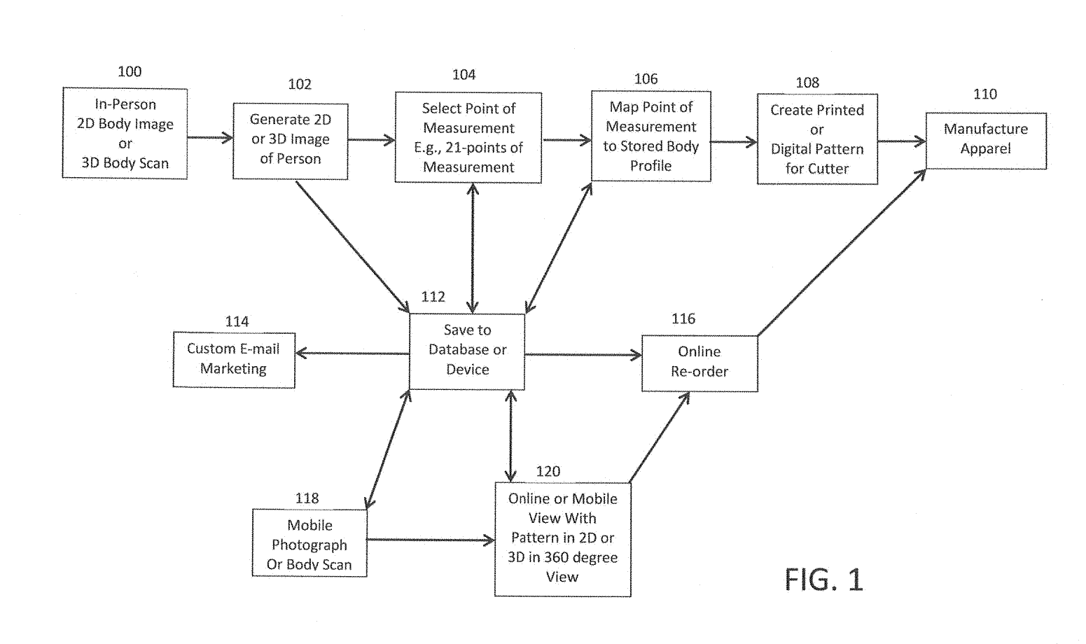

FIG. 1 is a flow diagram of an exemplary but not exclusive method for preparing custom clothing patterns practiced in accordance with some embodiments of the invention.

At step 100 in FIG. 1, an individual wanting to order customized, made-to-measure clothing begins by having their photograph taken or their body scanned using one or more cameras or body scanners. The photograph creates an image of the user's body to identify a series of points to form a two-dimensional image (2D image). It is envisioned, however, that the method and system described herein may utilize three-dimensional images also. As used herein, “three-dimensional image” or “3D image” refers to the creation of a 3D image from points identified during the scan and does not include compiled two-dimensional images. Cameras and body scanners are generally known in the art and may include white light and laser based scanners (e.g. body scanners utilizing Kinect technology), and additional modes of body scanning are also useful, including Wii and similar technology, mobile phone using multiple cameras from different angles, etc., or other methods of obtaining a highly accurate fully body image of the individual.

In one embodiment, the scanning process is performed at a place of business or outside of the home. In another embodiment the user does not need to wear specialized clothing (e.g., a bodysuit) for the purpose of the scan. In fact, the individual may simply wear form-fitting clothing or be unclothed. In another embodiment, the scanning process is performed by the user where a 2D image is generated by an imaging device such as a cell phone camera and provided to a user's computer. The computer includes any suitable platform such as a personal computer, laptop computer, tablets, personal digital assistant, smartphone, etc. The computer includes a processor accessing one or more tangible non-transitory computer media such as solid state storage and/or disk-based storage to undertake logic in accordance with present principles. The processor outputs visual images on a display and receives user input from one or more input device such as keypads, keyboards, point-and-click devices, etc. The computer can communicate using a network interface such as wired or wireless modem with the internet and specifically with one or more remote servers such as clothing provider servers having server processors accessing a server storage medium on which is stored clothing pattern images and logic in accordance with present principles.

At step 102, a two-dimensional (2D) image of the individual's body shape and relative size is created from the data acquired by the one or more body scanners of step 100. The data may be processed by the body scanner(s) itself or the data may be communicated and saved to a database 112 (e.g., locally or cloud-based) or device (e.g., a mobile device) for processing and creation of the 3D image. In one embodiment the body scanner or other device provides a higher resolution image of the individual's face. The higher resolution image may be by surface scan that accurately represents the individual's face and that may be colorized in further or concurrent image processing. For instance, in some embodiments it may be preferable to have a digital photograph of the face and exposed areas created and substituted for the data produced by the body scanner(s) to form a modified 2D image. The higher resolution further conveys a more realistic and personalized 2D body image to assist the individual in choosing a clothing style and fit more suitable to their overall visual appearance.

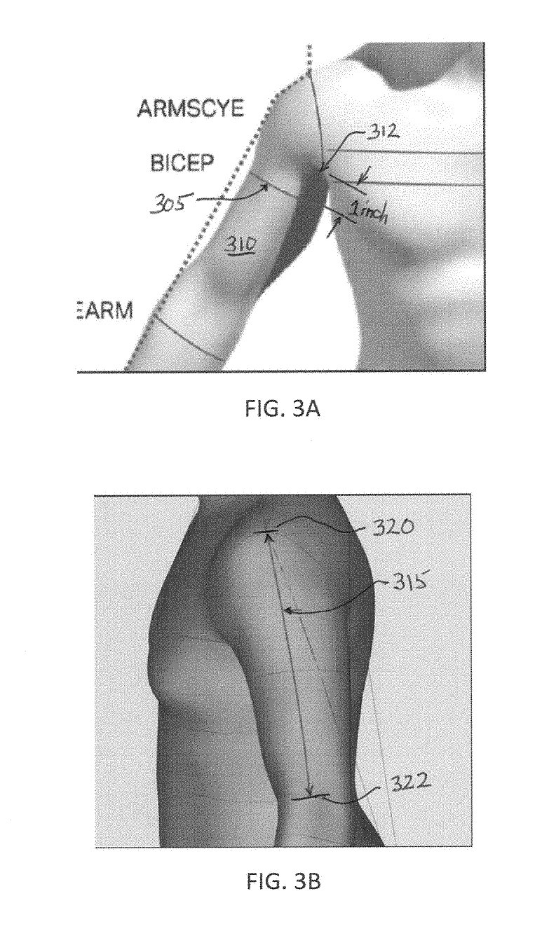

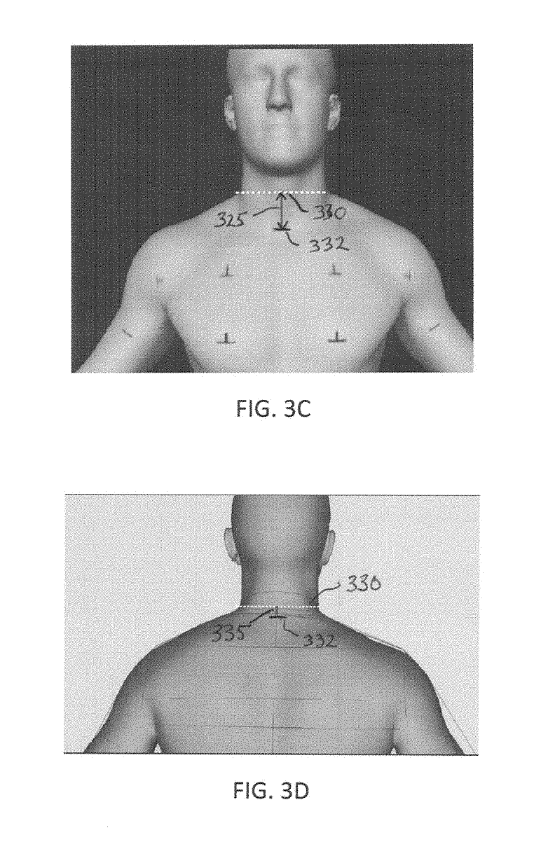

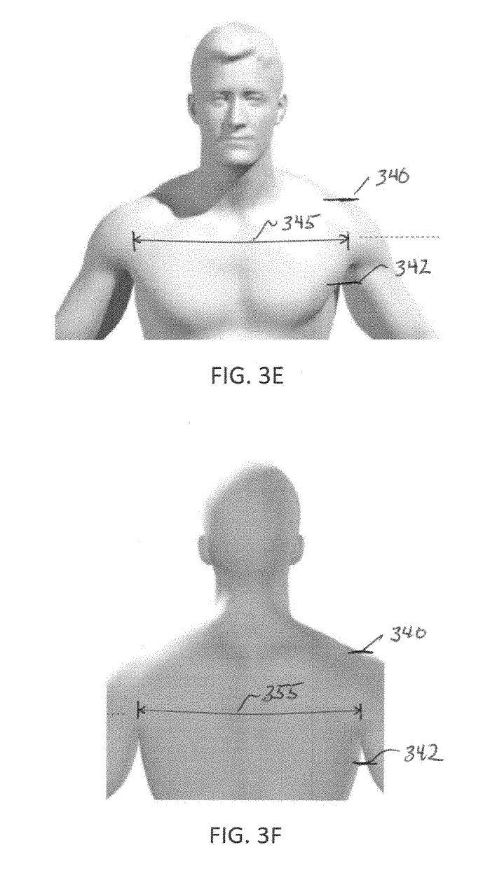

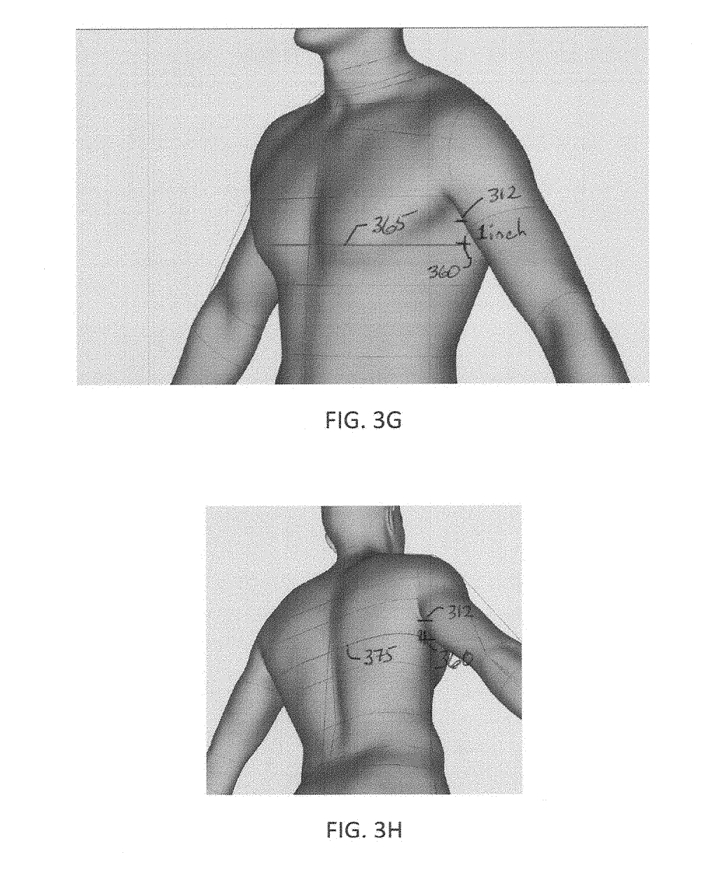

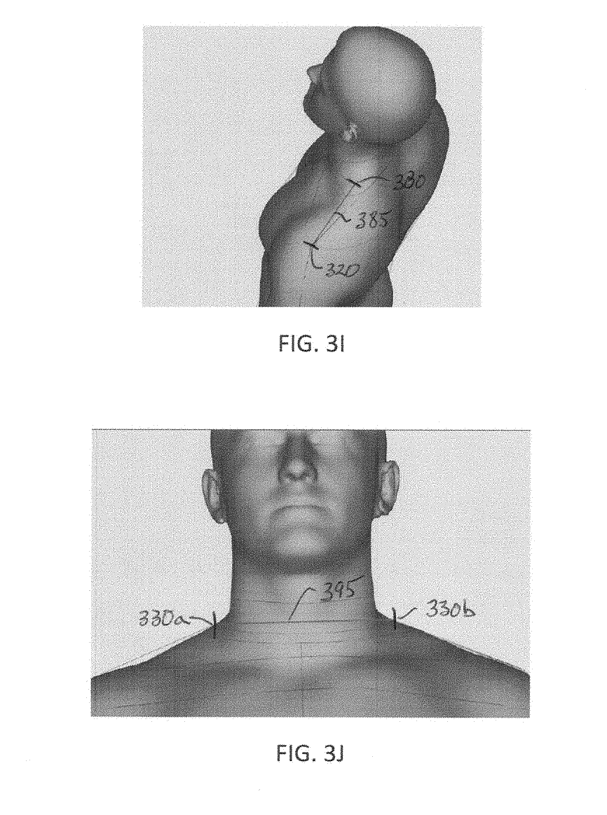

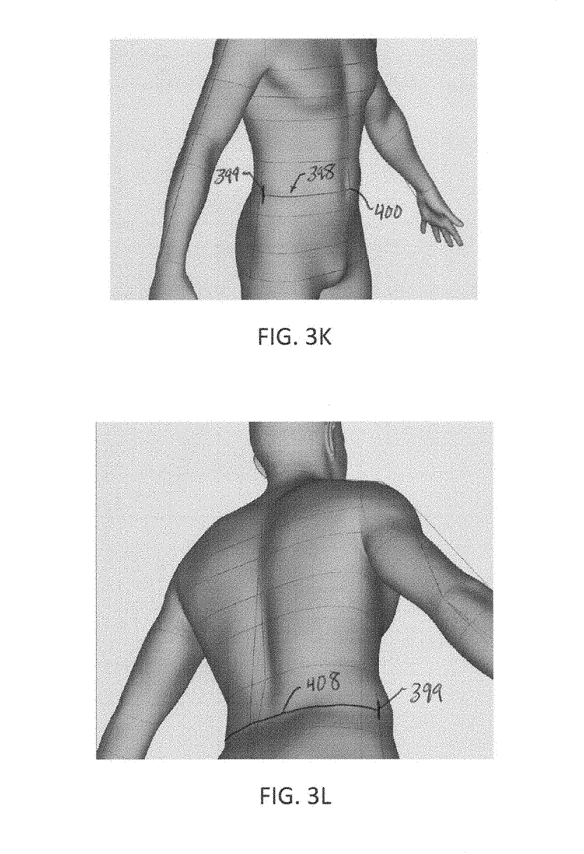

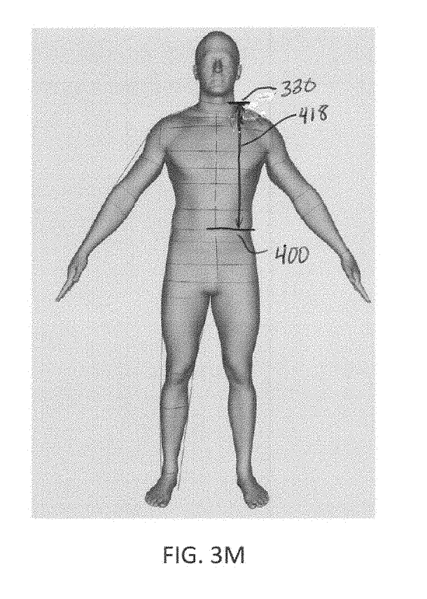

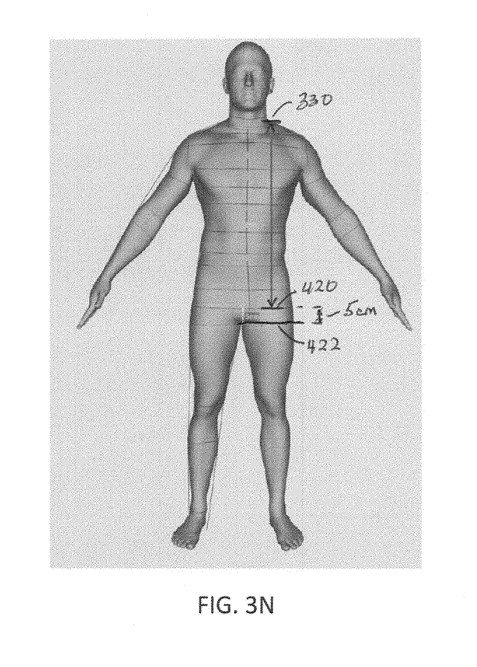

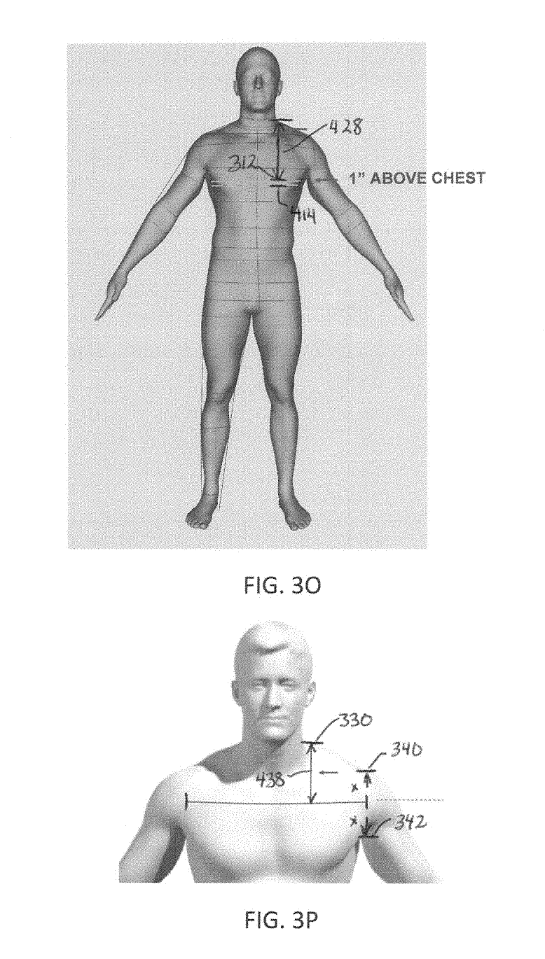

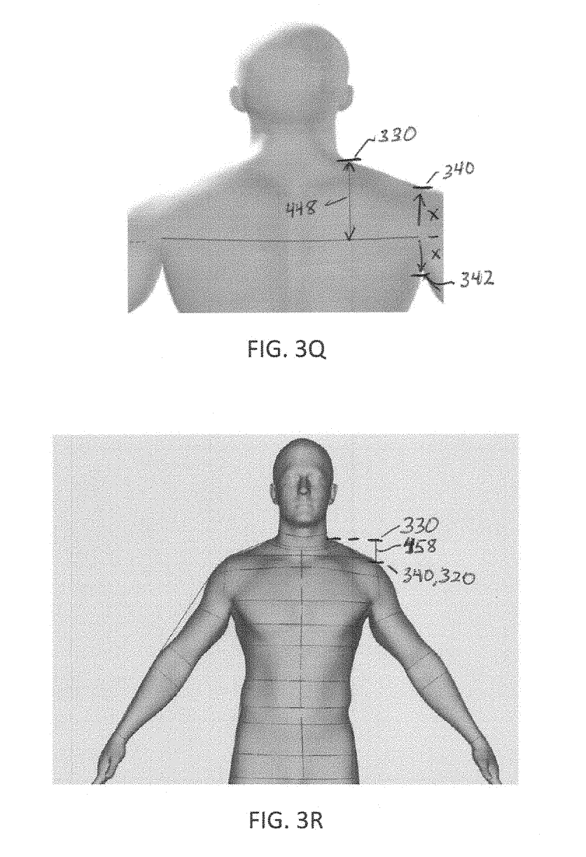

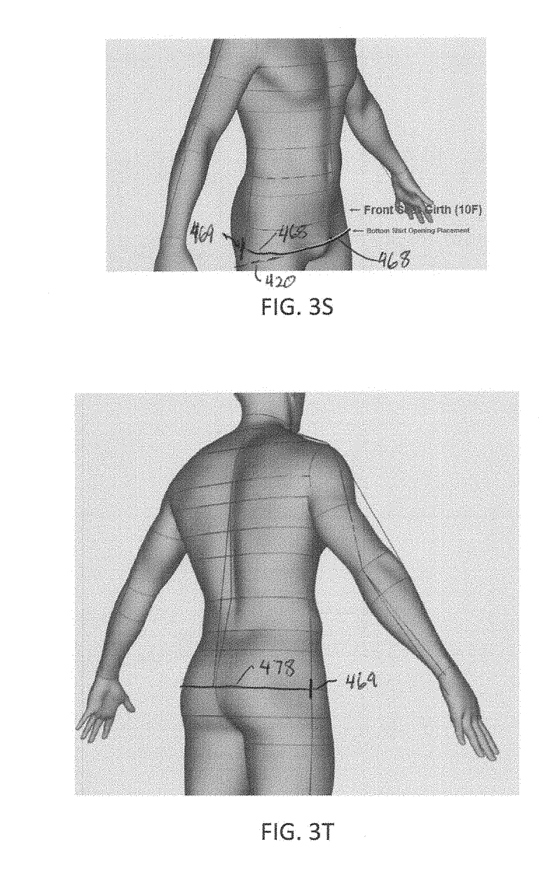

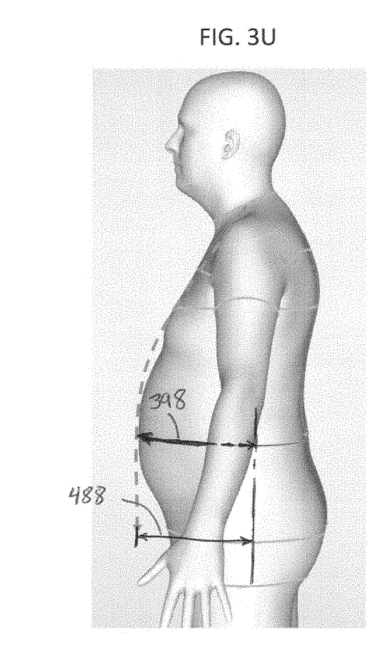

At step 104, points of measurement are extracted from the 2D image for creating a clothing pattern. The specific measurement assembled from the 2D images will be further described below with reference to FIGS. 3a-3p. In some embodiments the measurements are from a plurality of predetermined body points; e.g., 21 specific body measurements. In some embodiments, the predetermined body points comprise at least 10, 20, 30, 40, 50, 60, 70, 80, 90, 100, or more points on the individual's body. The measurements include but are not limited to height, neck circumference, width across the shoulders, the width across the shoulder blades, the width across the chest, chest circumference, the waist circumference, the hip circumference, the sleeve length, the seat, the rise, the hip, the thighs, and the wrist. Through software or hardware operable by the body scanner calculates the distances and the resulting measurements are representative of the physical size and shape of the individual's body parts to be clothed.

At step 106, the points of measurement are next mapped to one or more digital body profiles corresponding to the calculated measurements. In one embodiment, the measurements are automatically mapped to corresponding body types stored in a comprehensive database of body types. Therefore, the points of measurement may be mapped to one or more digital body morphologies corresponding to the calculated measurements through non-manual or manual input of measurements.

Clothing templates are preferably stored on database or device 112. The individual can view the appearance of the pattern on the individual's 2D image to evaluate its fit and save the 2D image with select patterns and styles to the database or device. It should be noted that by saving the information to the database or device permits more rapid future order processing such as by online re-orders in step 116.

In some embodiments, the individual may further customize, refine and personalize the digital pattern. With the overlaid customized clothing pattern upon the body image, the individual can select a fit based on known or established clothing styles as a base for further customization by the individual. For instance, the predetermined fits could include snug, form-fitting, blousy, slim fit, European fit, American fit, and further refinements like short cuffs, pleats, garment length, sleeve length, etc. Upon selecting a predetermined fit, the pattern may be modified without requiring correction of body point measurements, thereby preserving all 2D or 3D image data for future use, particularly if stored remotely. In this regard the individual may find that additional points of measurement beyond those initially selected in step 104 provide a more suitable fit. The individual may therefore select additional points of measurement for refining the pattern and customizing the desired fit and style such as dragging a measurement point graphically represented on a GUI to the desired location or by moving a slidable button on a scale to correspondingly adjust the location of a point of measurement. In combination with the above embodiments, or alternatively, manually inputting measurement data by keyboard is not required or desired. The individual may also save the initial pattern and any additional customized digital pattern to the database or device for future reference and use. This is particularly helpful where the individual multiple personal 2D or 3D images such as before and after weight gain. If the individual does not wish to have a new 2D or 3D body scan performed, he may simply go to the saved image and order a garment based on the saved fit and/or style, or further customize the saved pattern before ordering the garment. Moreover, storage on a remote server permits an individual to return without having to go through the body scanning and customization process again. Where the remote server is operated by a third party, for example, a clothier, it also permits third parties (spouses, assistants, friends, relatives, gift givers, and the like) to order custom, made-to-measure clothing for the individual without needing to know the individual's measurements.

In some embodiments, any information acquired from the body scan, or input or modified by the individual in customizing and selecting a desired fit or style, could potentially be used in direct consumer advertising as indicated by step 114 (identified as email marketing, although other forms of marketing such as mail or website when accessed by the individual are also contemplated).

At step 108, after the individual has completed customization of the digital pattern and is satisfied with the pattern on the individual's 2D image, the pattern is ready to be sent to a digital cutting machine or printed for cutting of the final pattern for manufacturing, i.e., assembly of the pattern piece or pieces into wearable apparel or accessories. Digital cutting machines suitable for this step include but are not limited to the Gerber Z1, DCS 1500, DCS 2500, Taurus II Leather Cutter, Paragon, GTxL, XLc7000 and Z7. In some embodiments, the cutting machine is capable of automated creation of custom-fitted apparel patterns in response to the transmitted data.

Automatically generated custom patterns are sent in digital form to be cut and then used as part of an efficient mass customization process. Many aspects of garment construction can be automated.

After the patterns are cut, they are ready to be assembled according to step 110. While assembly is preferably performed by a professional (i.e., tailor or seamstress), anyone, including the individual, may assemble the pieces. As such, it is contemplated that manufacture of step 110 comprises sending the pieces from the site of cutting to the professional's or individual's place of business or home for assembly.

At step 118, instead of having to travel to facility for an in-person body scan identified in step 100, an individual can instead have a highly personalized 2D photograph or 3D body scan performed by an application on their mobile device.

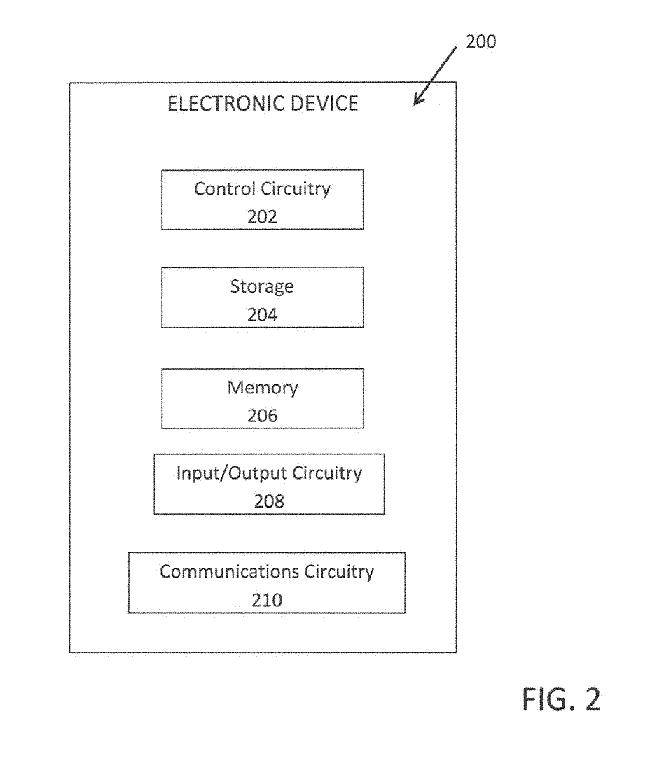

FIG. 2 is a block diagram of an illustrative but not limiting electronic device for performing an application operative for creating a 2D photograph and/or 3D body scan and previewing application of apparel and accessories in accordance with some embodiments of the invention. Electronic device 200 can include control circuitry 202, storage 204, memory 206, input/output (“I/O”) circuitry 208, and communications circuitry 210. In some embodiments, one or more of the components of electronic device 200 can be combined or omitted (e.g., storage 204 and memory 206 may be combined). In some embodiments, electronic device 200 can include other components not combined or included in those shown in FIG. 2 (e.g., motion detection components, a power supply such as a battery or kinetics, a display, bus, a positioning system, a camera, an input mechanism, etc.), or several instances of the components shown in FIG. 2. For the sake of simplicity, only one of each of the components is shown in FIG. 2.

Electronic device 200 can include any suitable type of electronic device. For example, electronic device 200 can include a portable electronic device that the user may hold in his or her hand, such as a smartphone (e.g., an iPhone made available by Apple Inc. of Cupertino, Calif. or an Android device such as those produced and sold by Samsung). As another example, electronic device 200 can include a larger portable electronic device, such as a tablet or laptop computer. As yet another example, electronic device 200 can include a substantially fixed electronic device, such as a desktop computer.

Control circuitry 202 can include any processing circuitry or processor operative to control the operations and performance of electronic device 200. For example, control circuitry 202 can be used to run operating system applications, firmware applications, media playback applications, media editing applications, or any other application. In some embodiments, control circuitry 202 can drive a display and process inputs received from a user interface.

Storage 204 can include, for example, one or more storage mediums including a hard-drive, solid state drive, flash memory, permanent memory such as ROM, any other suitable type of storage component, or any combination thereof. Storage 204 can store, for example, media data (e.g., music and video files), application data (e.g., for implementing functions on electronic device 200), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 200 to establish a wireless connection), subscription information data (e.g., information that keeps track of podcasts or television shows or other media a user subscribes to), contact information data (e.g., telephone numbers and email addresses), calendar information data, and any other suitable data or any combination thereof

Memory 206 can include cache memory, semi-permanent memory such as RAM, and/or one or more different types of memory used for temporarily storing data. In some embodiments, memory 206 can also be used for storing data used to operate electronic device applications, or any other type of data that can be stored in storage 204. In some embodiments, memory 206 and storage 204 can be combined as a single storage medium.

I/O circuitry 208 can be operative to convert (and encode/decode, if necessary) analog signals and other signals into digital data. In some embodiments, I/O circuitry 208 can also convert digital data into any other type of signal, and vice-versa. For example, I/O circuitry 208 can receive and convert physical contact inputs (e.g., from a multi-touch screen), physical movements (e.g., from a mouse or sensor), analog audio signals (e.g., from a microphone), or any other input. The digital data can be provided to and received from control circuitry 202, storage 204, memory 206, or any other component of electronic device 200. Although I/O circuitry 208 is illustrated in FIG. 2 as a single component of electronic device 200, several instances of I/O circuitry 208 can be included in electronic device 200.

Electronic device 200 can include any suitable interface or component for allowing a user to provide inputs to I/O circuitry 208. For example, electronic device 200 can include any suitable input mechanism, such as for example, a button, keypad, dial, a click wheel, or a touch screen. In some embodiments, electronic device 200 can include a capacitive sensing mechanism, or a multi-touch capacitive sensing mechanism.

In some embodiments, electronic device 200 can include specialized output circuitry associated with output devices such as, for example, one or more audio outputs. The audio output can include one or more speakers (e.g., mono or stereo speakers) built into electronic device 200, or an audio component that is remotely coupled to electronic device 200 (e.g., a headset, headphones or earbuds that can be coupled to communications device with a wire or wirelessly).

In some embodiments, I/O circuitry 208 can include display circuitry (e.g., a screen or projection system) for providing a display visible to the user. For example, the display circuitry can include a screen (e.g., an LCD screen) that is incorporated in electronics device 200. As another example, the display circuitry can include a movable display or a projecting system for providing a display of content on a surface remote from electronic device 200 (e.g., a video projector). In some embodiments, the display circuitry can include a coder/decoder (CODEC) to convert digital media data into analog signals. For example, the display circuitry (or other appropriate circuitry within electronic device 200) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 202. Alternatively, the display circuitry can be operative to provide instructions to a remote display.

Communications circuitry 210 can include any suitable communications circuitry operative to connect to a communications network and to transmit communications (e.g., voice or data) from electronic device 200 to other devices within the communications network. Communications circuitry 210 can be operative to interface with the communications network using any suitable communications protocol such as, for example, Wi-Fi (e.g., a 802.11 protocol), Bluetooth., radio frequency systems (e.g., 900 MHz, 1.4 GHz, and 5.6 GHz communication systems), infrared, GSM, GSM plus EDGE, CDMA, LTE and other cellular protocols, VOIP, or any other suitable protocol.

In some embodiments, communications circuitry 210 can be operative to create a communications network using any suitable communications protocol. For example, communications circuitry 210 can create a short-range communications network using a short-range communications protocol to connect to other devices. For example, communications circuitry 210 can be operative to create a local communications network using the Bluetooth protocol to couple electronic device 200 with a Bluetooth headset.

Electronic device 200 can include one more instances of communications circuitry 210 for simultaneously performing several communications operations using different communications networks, although only one is shown in FIG. 2 to avoid overcomplicating the drawing. For example, electronic device 200 can include a first instance of communications circuitry 210 for communicating over a cellular network, and a second instance of communications circuitry 210 for communicating over Wi-Fi or using Bluetooth. In some embodiments, the same instance of communications circuitry 210 can be operative to provide for communications over several communications networks.

In some embodiments, electronic device 200 can be coupled a host device for data transfers, synching the communications device, software or firmware updates, providing performance information to a remote source (e.g., providing riding characteristics to a remote server) or performing any other suitable operation that can require electronic device 200 to be coupled to a host device. Several electronic devices 200 can be coupled to a single host device using the host device as a server. Alternatively or additionally, electronic device 200 can be coupled to several host devices (e.g., for each of the plurality of the host devices to serve as a backup for data stored in electronic device 200).

At step 118, as mentioned above, in some embodiments an electronic device (e.g., electronic device 100 of FIG. 2) may include an integrated application operative to perform a highly accurate 2D imagery and/or 3D body scan of the individual.

At step 120, the integrated application is operative to allow the individual to select a 2D and/or 3D image of the individual, select an article of clothing to view, alter the image of the article of clothing (i.e., the digital pattern) to fit the predetermined points of measurement and any additional points of measurement selected by the user, and applying or overlaying the article of clothing to the individual's 3D image so that the individual may evaluate the fit. Thus, the integrated application permits the individual to perform steps 102, 104, 106, 108 of FIG. 1 as described above. The application may also permit the “clothed” 2D and/or 3D image to rotate in 360 degree view for more thorough evaluation by the individual.

In some embodiments, an electronic device (e.g., electronic device 100 of FIG. 2) may include an integrated application operative to interface with a database or another device having stored thereon an individual's 2D and/or 3D image and customized/refined points of measurement and selected clothing patterns that are viewable on the electronic device, which is in turn able to execute an online order via control circuitry 210 as noted by step 116 of FIG. 1. The integrated application permits the selection of one or more 2D and/or 3D images of the individual for viewing, selecting and ordering of clothing patterns.

FIGS. 3A-3U illustrate different measurement locations utilized for the generation of a clothing pattern for a t-shirt according to one embodiment of the present invention. Each view shown in FIGS. 3A-3U will now be described in details to illustrate one embodiment for providing measurement values used to define the body type for correlation to a specific morphology.

FIG. 3A illustrates a measurement of the circumference 305 of the upper arm 310 or bicep which is taken from allocation that is one inch (1″) below the underarm point (armpit) 312.

FIG. 3B illustrates a measurement of the sleeve length 315 as measured from the top of the acromion 320 to the top of the elbow 322.

FIG. 3C illustrates a measurement of the neck drop 325 as measured from the high point of the shoulders (HPS) 330 to the top of the cervical 332.

FIG. 3D illustrates a measurement of the center back neck drop 335 as measured in the vertical direction from the highpoint of the shoulder 330 to the top of the cervical 332 as viewed from the back of the person.

FIG. 3E illustrates a measurement of the front chest width 345 from armhole to armhole, where the armholes are midway between the shoulders 340 and the armhole base 342 as viewed from the front of the subject person.

FIG. 3F illustrates a measurement of the front chest width 355 from armhole to armhole, where the armholes are midway between the shoulders 340 and the armhole base 342 as viewed from the rear of the subject person.

FIG. 3G illustrates a horizontal front chest measurement 365 from side-body to side-body 360 and one inch (1″) below the armpit 312. This measurement 365 is effectively half of the circumference of the subject person at the location shown in FIG. 3G.

FIG. 3H illustrates a horizontal back chest measurement 375 from side-body to side-body 360 and one inch (1″) below the armpit 312. This measurement 375 is effectively half of the circumference of the subject person at the location shown in FIG. 3H.

FIG. 3I illustrates a shoulder length measurement 385 as taken from the high point of the shoulder (HPS) 330 to the acromion 320.

FIG. 3J illustrates a neck width measurement 395 from the left high point of the shoulder 330a to the right high point of the shoulder 330b.

FIG. 3K illustrates a horizontal front wait measurement 398 from side-body 399 to side-body (not shown but mirror image of 399) at the belly button height 400. It is noted however that it may be appropriate to use a front seat girth measurement if the front seat girth measurement is greater than the front waist measurement 398. The front seat girth measurement will be described in more detail below with respect to FIG. 3U.

FIG. 3L illustrates a horizontal back waist measurement 408 from side-body 399 to side-body (not shown but mirror image of 399) at the belly button height 400.

FIG. 3M illustrates a front waist placement measurement 418 from the high point of the shoulders 330 to the belly button waist height 400.

FIG. 3N illustrates a back length placement measurement 418 from the high point of the shoulders 330 to the bottom opening of the shirt height 420 which is defined as five centimeters (5 cm) above the crotch 422.

FIG. 3O illustrates an armhole depth 428 from the high point of the shoulders 330 to the armpit 312, The vertical chest location 414 is defined as one inch (1″) below the armpit 312.

FIG. 3P illustrates the across front placement measurement 438 as located from the high point of the shoulders 330, and is defined as the vertical height from the high point of the shoulders 330 to midway between the shoulder 340 and armhole base 342.

FIG. 3Q illustrates the across back placement measurement 448 as located from the high point of the shoulders 330, and is defined as the vertical height from the high point of the shoulders 330 to midway between the shoulder 340 and armhole base 342 as viewed from the rear of the subject person.

FIG. 3R illustrates the shoulder slope measurement 458 which is defined as the vertical height from the high point of the shoulder 330 to the acromion 320 at the shoulder 340.

FIG. 3S illustrates the front seat girth measurement 468 which is defined as the horizontal length from side-body 469 to side-body (not shown but mirror image of 469) at the fullest point with the height selected to be the same as the shirt height 420 of FIG. 3N.

FIG. 3T illustrates the back seat girth measurement 478 which is defined as the horizontal length from side-body 469 to side-body (not shown but mirror image of 469) at the fullest point with the height selected to be the same as the shirt height 420 of FIG. 3N.

FIG. 3U illustrates the front seat girth 488. When viewing the front waist 398 and the front seat girth 488, the higher value should be chosen and used from both points of measurement.

The following exemplary embodiment will utilize 4 male and 5 female body morphologies that were produced from extensive body data based on the collection of data throughout North America. All body data measurements generated from the collected data will identify the body morph type based on a chest to waist ratio formula.

The present invention will accommodate each of these body morphologies. Each example contains body measurements of the virtual avatar as well as the pattern measurements developed for each virtual avatar.

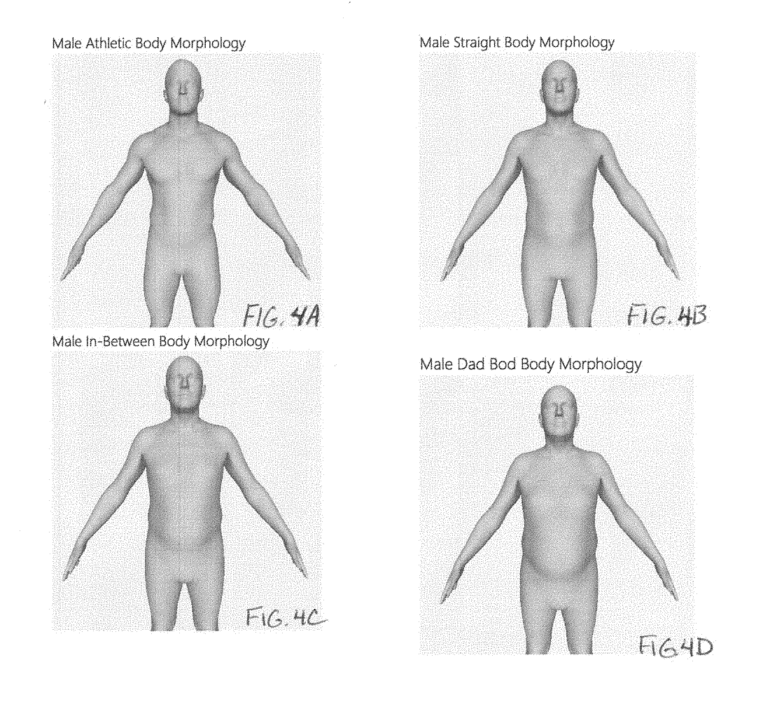

FIGS. 4A-4D illustrate four (4) different male morphologies with FIG. 4A illustrating a male athletic body morphology, FIG. 4B illustrating a male straight body morphology; FIG. 4C illustrating a male in-between body morphology, and FIG. 4D illustrating a male dad bod body morphology.

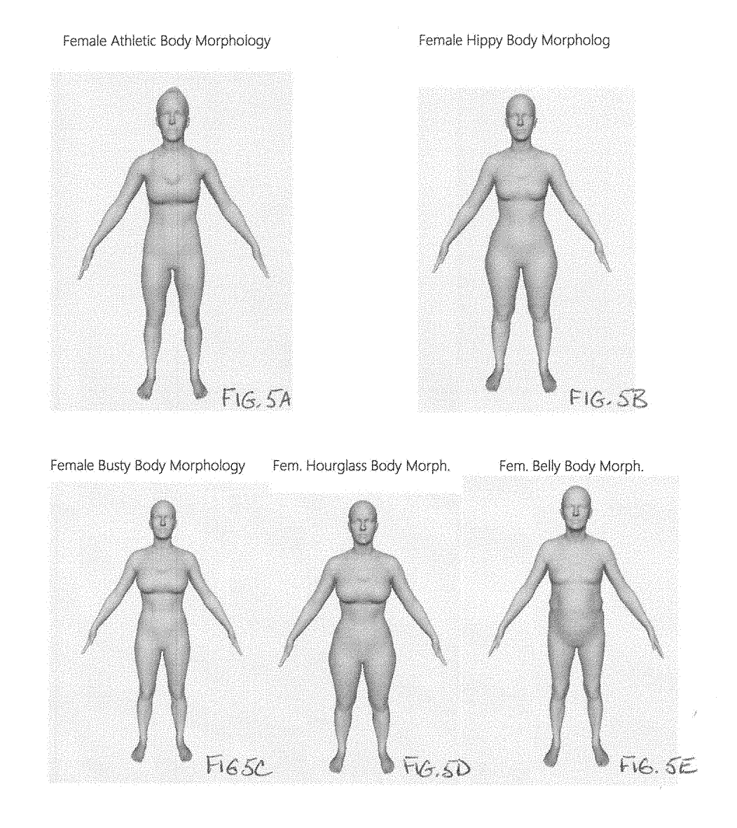

FIGS. 5A-5E illustrate five (5) different female morphologies with FIG. 5A illustrating a female athletic body morphology, FIG. 5B illustrating a female hippy body morphology; FIG. 5C illustrating a female busty body morphology, FIG. 5D illustrating a female hourglass body morphology, and FIG. 5E illustrating a female belly body morphology.

With the process and system of this invention, the body measurements described above with respect to FIGS. 3A-3U are received and saved, then these measurements are matched to a specific body type morphology. Based on this morphology selection, the system of this invention will then determine the proper clothing patterns to form a suitable custom garment; e.g., a t-shirt, according to the present invention.

The processes discussed above are intended to be illustrative and not limiting. Persons skilled in the art will appreciate that steps of the process discussed herein can be omitted, modified, combined, or rearranged, and any additional steps can be performed without departing from the scope of the invention.

The application can be implemented by software, but can also be implemented in hardware or a combination of hardware and software. The invention can also be embodied as computer-readable code on a computer-readable medium. The computer-readable medium can include any data storage device that can store data which can thereafter be read by a computer system. Examples of the computer readable medium include read-only memory (“ROM”), random-access memory (“RAM”), CD-ROMs, DVDs, magnetic tape, optical data storage device, flash storage devices, or any other suitable storage devices. The computer-readable medium can also be distributed over network coupled computer systems.

Insubstantial changes from the claimed subject matter as viewed by a person with ordinary skill in the art, now known or later devised, are expressly contemplated as being equivalently within the scope of this disclosure. Therefore, obvious substitutions now or later known to one with ordinary skill in the art are defined to be within the scope of the defined elements.

The above-described embodiments of the present invention are presented for purposes of illustration and not of limitation.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure and can be combined or used with embodiments or features disclosed in U.S. Provisional Patent Application No. 62/624,252 entitled SYSTEM AND METHOD FOR PREPARING CUSTOM CLOTHING PATTERNS, filed Jan. 31, 2018, which is incorporated herein by reference in their entireties. This disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A computer-implemented process for preparing custom clothing patterns, the computer-implemented process comprising:
receiving a two-dimensional image of an individual;
determining points of measurements of the individual from the two-dimensional image;
selecting a predetermined body morphology from a plurality of body morphologies; said selecting comprising a matching of said points of measure to a select body morphology,
modulating a digital clothing pattern template comprising measurement locations corresponding to the points of measurements and said select body morphology by applying the measurements to the corresponding measurement locations of the digital pattern template, and
altering the pattern based on the measurements and personal preferences.

2. The computer-implemented process of claim 1, wherein said points of measurement comprise at least twenty-one specific body measurements.

3. The computer-implemented process of claim 1, wherein said plurality of body morphologies are crated in advance of said step of receiving and stored in a database.

4. The computer-implemented process of claim 1, further comprising:
receiving facial images of said individual which are created and substituted for the data produced to define said two-dimensional image, whereby a, higher resolution further conveys a more realistic and personalized two-dimensional image to assist the individual in choosing a clothing style and fit more suitable to overall visual appearance.

5. The computer-implemented process of claim 4, further comprising:
receiving images of other exposed body arts in additional to said facial images of said individual.

6. The computer-implemented process of claim 1, further comprising:
overlaying said pattern upon the two-dimensional image, whereby the individual can select a desired fit and styles as a base for further customization by the individual.

7. The computer-implemented process of claim 6, further comprising:
selecting additional points of measurement for refining the pattern and customizing said desired fit and style such as dragging a measurement point graphically represented on a GUI to the desired location or by moving a slidable button on a scale to correspondingly adjust the location of a point of measurement.

8. The computer-implemented process of claim 1, further comprising:
customizing the pattern based on customer preferences.

9. The computer-implemented process of claim 1, wherein creating the pattern comprises:
displaying one or more options related to the garment to be manufactured to the customer;
receiving selection corresponding to the displayed one or more options; and creating the pattern for the customer based on the received selection from the customer.

10. The computer-implemented process of claim 9,
wherein the one or more options related to garment comprises type of garment, style of garment, color of garment, and fabric of garment.

11. A computer program product comprising:
a computer-readable storage device; and
a computer-readable program code stored in the computer-readable storage device, the computer readable program code containing instructions executable by a processor of a computer system to implement a method to prepare custom clothing patterns, the method comprising:
receiving a two-dimensional image of an individual;
determining points of measurements of the individual from the two-dimensional image;
selecting a predetermined body morphology from a plurality of body morphologies; said selecting comprising a matching of said points of measure to a select body morphology,
modulating a digital clothing pattern template comprising measurement locations corresponding to the points of measurements and said select body morphology by applying the measurements to the corresponding measurement locations of the digital pattern template, and
altering the pattern based on the measurements and personal preferences.

12. The computer program product of claim 11, wherein said points of measurement comprise at least twenty-one specific body measurements.

13. The computer program product of claim 11, wherein said plurality of body morphologies are crated in advance of said step of receiving and stored in a database.

14. The computer program product of claim 11, further comprising:
receiving facial images of said individual which are created and substituted for the data produced to define said two-dimensional image, whereby a, higher resolution further conveys a more realistic and personalized two-dimensional image to assist the individual in choosing a clothing style and fit more suitable to overall visual appearance.

15. The computer program product of claim 14, further comprising:
receiving images of other exposed body arts in additional to said facial images of said individual.

16. The computer program product of claim 11, further comprising:
overlaying said pattern upon the two-dimensional image, whereby the individual can select a desired fit and styles as a base for further customization by the individual.

17. The computer program product of claim 16, further comprising a step of:
selecting additional points of measurement for refining the pattern and customizing said desired fit and style such as dragging a measurement point graphically represented on a GUI to the desired location or by moving a slidable button on a scale to correspondingly adjust the location of a point of measurement.

18. A computer system, comprising:
a processor;
a memory coupled to said processor; and
a computer readable storage device coupled to the processor, the storage device containing instructions executable by the processor via the memory to implement a method to prepare custom clothing patterns, the method comprising the steps of:
receiving a two-dimensional image of an individual;
determining points of measurements of the individual from the two-dimensional image;
selecting a predetermined body morphology from a plurality of body morphologies; said selecting comprising a matching of said points of measure to a select body morphology,
modulating a digital clothing pattern template comprising measurement locations corresponding to the points of measurements and said select body morphology by applying the measurements to the corresponding measurement locations of the digital pattern template, and
altering the pattern based on the measurements and personal preferences.

19. The computer system of claim 18, further comprising a step of:
receiving facial images of said individual which are created and substituted for the data produced to define said two-dimensional image, whereby a, higher resolution further conveys a more realistic and personalized two-dimensional image to assist the individual in choosing a clothing style and fit more suitable to overall visual appearance.

20. The computer system of claim 18, further comprising a step of:
receiving images of other exposed body arts in additional to said facial images of said individual.
